(19) United States
(12) Patent Application Publication
(10) Pub. No.: US 2023/0158610 A1
(43) Pub. Date: May 25, 2023

(54) WELDING QUALITY DETECTION SYSTEM AND ULTRASONIC WELDING DEVICE, AND WELDING QUALITY DETECTION METHOD

(71) Applicant: Guangdong Lyric Robot Automation Co., Ltd., Huizhou City (CN)

(72) Inventors: Junxiong Zhou, Huizhou City (CN); Yixian Du, Huizhou City (CN); De Chen, Huizhou City (CN); Qihui Lu, Huizhou City (CN); Peng Fan, Huizhou City (CN)

(73) Assignee: Guangdong Lyric Robot Automation Co., Ltd., Huizhou City (CN)

(21) Appl. No.: 17/774,108

(22) PCT Filed: Feb. 25, 2022
(86) PCT No.: PCT/CN2022/078040

§ 371 Date: May 3, 2022

(30) Foreign Application Priority Data
Feb. 26, 2021 (CN) 202110216871.7

(51) Int. Cl. B23K 31/12

(52) U.S. Cl. CPC B23K 31/125

(57) ABSTRACT

A welding quality detection system and an ultrasonic welding device, and a welding quality detection method are disclosed. The welding quality detection system includes a detection module, a control module and a display module. The detection module is configured for collecting a transverse friction force and a longitudinal welding pressure of a welded workpiece. The control module is electrically connected with the detection module, and the control module is configured for receiving, analyzing and processing a transverse friction force signal and a longitudinal welding pressure signal of the detection module. The display module is electrically connected with the control module, and the display module is configured for displaying analysis results of the control module. According to the application, a welding quality of the welded workpiece can be effectively detected, and a welding defect can be found in real time.

### CROSS-REFERENCE TO RELATED APPLICATION

This application is a national stage filing under 35 U.S.C. § 371 of international application number PCT/CN2022/078040, filed Feb. 25, 2022, which claims priority to Chinese patent application No. 202110216871.7, filed Feb. 26, 2021. The contents of these applications are incorporated herein by reference in their entirety for all purposes.

### TECHNICAL FIELD

The disclosure relates to the technical field of ultrasonic welding, and more particularly, to a welding quality detection system and an ultrasonic welding device, and a welding quality detection method.

### BACKGROUND

An ultrasonic metal welding machine is configured for welding two or more workpieces, and different surface qualities of workpieces to be welded, such as surface smoothness, oil stain and dust, may lead to a change of a shearing force or a friction force in welding, wherein the factors affecting the friction force include material selection (such as a copper or aluminum composition, and a purity thereof), surface coating, grease between lugs or wire harnesses, additive and dirt, storage environment and time of materials, surface damage of materials, and longitudinal welding pressure, thus affecting welding quality (welding strength), such as causing problems of insufficient welding and insufficient tension.

When a plurality of workpieces are welded by the ultrasonic metal welding machine, ultrasonic vibration is transmitted to a pressed metal sheet, and oil stains and decomposed oxides on a surface of a material are cleaned through tangential vibration, so that clean contact is formed between multiple layers of metal sheets. At the moment, electrons share atoms on two sides on the contact surface to form connection. However, most welding defects are difficult to be identified before failure, and costs caused by the defects are high, so that it is necessary to effectively detect the welding quality.

### SUMMARY

The disclosure aims to solve at least one of the technical problems in the existing technology.

Therefore, the disclosure provides a welding quality detection system capable of effectively detecting a welding quality of a welded workpiece and finding a welding defect in real time.

The disclosure also provides an ultrasonic welding device equipped with the welding quality detection system above.

The disclosure also provides a welding quality detection method applied in the welding quality detection system.

A welding quality detection system according to an embodiment in a first aspect of the disclosure includes: a detection module configured for collecting a transverse friction force and a longitudinal welding pressure of a welded workpiece; a control module, wherein the control module is electrically connected with the detection module, and the control module is configured for receiving, analyzing and processing a transverse friction force signal and a longitudinal welding pressure signal of the detection module; and a display module electrically connected with the control module, wherein the display module is configured for displaying analysis results of the control module.

The technical solution above at least has the following beneficial effects. The detection module collects the transverse friction force and the longitudinal welding pressure of the welded workpiece in real time, and the control module receives the signals of the detection module, and analyzes and processes the transverse friction force and the longitudinal welding pressure of the welded workpiece, so as to judge whether the welded workpiece is a qualified product, and display the analysis results to the display module for feeding back to an operator in real time. Therefore, the operator can judge the welding quality of the welded workpiece in real time and find a workpiece with a welding defect in advance, thus avoiding a potential safety hazard or a cost waste caused by the defect in a later stage.

According to some embodiments of the disclosure, the detection module includes a multi-dimensional force sensor configured for collecting the transverse friction force and the longitudinal welding pressure of the welded workpiece and respectively converting the same into analog voltage signals.

According to some embodiments of the disclosure, the display module includes a human-machine interface (HMI), a personal computer (PC) or an indicator lamp, which is capable of intuitively displaying the analysis results.

An ultrasonic welding device according to an embodiment in a second aspect of the disclosure includes: a holder provided with a welding base; a welding member slidably connected to the holder in an up-down direction, wherein the welding member is located above the welding base; a driving member connected with the welding member and driving the welding member to move up and down; and the welding quality detection system according to the embodiment in the first aspect above, wherein the detection module is mounted on the welding base.

The technical solution above at least has the following beneficial effects. In the ultrasonic welding device, the detection module collects the transverse friction force and the longitudinal welding pressure of the welded workpiece in real time, and the control module receives the signals of the detection module, and analyzes and processes the transverse friction force and the longitudinal welding pressure of the welded workpiece, so as to judge whether the welded workpiece is a qualified product, and display the analysis results to the display module for feeding back to an operator in real time. Therefore, the operator can judge the welding quality of the welded workpiece in real time and find a workpiece with a welding defect in advance, thus avoiding a potential safety hazard or a cost waste caused by the defect in a later stage.

A welding quality detection method applied in a welding quality detection system of an ultrasonic welding device according to an embodiment in a third aspect of the disclosure is provided. The welding quality detection system includes a detection module, a control module and a display module, the detection module is configured for collecting a transverse friction force and a longitudinal welding pressure of a welded workpiece; the control module is electrically connected with the detection module, the control module is configured for receiving, analyzing and processing a transverse friction force signal and a longitudinal welding pressure signal of the detection module; the display module is electrically connected with the control module, and the display module is configured for displaying analysis results of the control module. The welding quality detection method includes: respectively acquiring reference value ranges of the transverse friction force and the longitudinal welding pressure, and setting the reference value ranges in the control module; collecting, by the detection module, the transverse friction force and the longitudinal welding pressure of the welded workpiece in real time and respectively transmitting the same to the control module in a form of electrical signals; respectively comparing, by the control module, the transverse friction force and the longitudinal welding pressure with corresponding reference value ranges; and transmitting, by the control module, the analysis results to the display module, and displaying, by the display module, the analysis results.

The technical solution above at least has the following beneficial effects. The detection module collects the transverse friction force and the longitudinal welding pressure of the welded workpiece in real time, and the control module receives the signals of the detection module, and respectively compares the transverse friction force and the longitudinal welding pressure of the welded workpiece with the corresponding reference value ranges, so as to judge whether the welded workpiece is a qualified product, and display the analysis results to the display module for feeding back to an operator in real time. Therefore, the operator can judge the welding quality of the welded workpiece in real time and find a workpiece with a welding defect in advance, thus avoiding a potential safety hazard or a cost waste caused by the defect in a later stage.

According to some embodiments of the disclosure, respectively acquiring reference value ranges of the transverse friction force and the longitudinal welding pressure includes: collecting transverse friction forces and longitudinal welding pressures of small-batch-sample welded workpieces; respectively carrying out quality analysis on each sample welded workpiece; recording the transverse friction forces and the longitudinal welding pressures of the sample welded workpieces that are qualified products; calculating an average value pl and a deviation value D1 of the transverse friction forces, and calculating an average value μ2 and a deviation value D2 of the longitudinal welding pressures; and determining the reference value range of the transverse friction force according to the average value pl and the deviation value D1, and determining the reference value range of the longitudinal welding pressure according to the average value μ2 and the deviation value D2, so as to acquire accurate reference value ranges.

According to some embodiments of the disclosure, the quality analysis includes a tensile test and micro-structure analysis, so that the welding quality of the sample welded workpieces can be accurately judged.

According to some embodiments of the disclosure, respectively acquiring reference value ranges of the transverse friction force and the longitudinal welding pressure includes: collecting transverse friction forces and longitudinal welding pressures of small-batch-sample welded workpieces; respectively sorting out the transverse friction forces and the longitudinal welding pressures of the sample welded workpieces by normal distribution statistics; and determining a numerical range within three standard deviations from an average value of the transverse friction forces as the reference value range of the transverse friction force, and determining a numerical range within three standard deviations from an average value of the longitudinal welding pressures as the reference value range of the longitudinal welding pressure, so that another type of reference value range can be acquired, and accuracy of welding quality detection can be further improved.

According to some embodiments of the disclosure, respectively sorting out the transverse friction forces and the longitudinal welding pressures of the sample welded workpieces by normal distribution statistics includes: counting a number of values of the transverse friction forces and a number of values of the longitudinal welding pressures and respectively drawing normal distribution diagrams, and calculating the average value and the standard deviation of the transverse friction forces and calculating the average value and the standard deviation of the longitudinal welding pressures.

According to some embodiments of the disclosure, respectively comparing, by the control module, the transverse friction force and the longitudinal welding pressure with corresponding reference value ranges includes: comparing the transverse friction force collected in real time with the reference value range of the transverse friction force, and comparing the longitudinal welding pressure collected in real time with the reference value range of the longitudinal welding pressure; and if the transverse friction force exceeds the reference value range of the transverse friction force and/or the longitudinal welding pressure exceeds the reference value range of the longitudinal welding pressure, judging the welded workpiece as an unqualified product, and if the transverse friction force is within the reference value range of the transverse friction force and the longitudinal welding pressure is within the reference value range of the longitudinal welding pressure, judging the welded workpiece as a qualified product.

The additional aspects and advantages of the disclosure will be given in part in the following description and will become apparent in part from the following description, or will be learned through the practice of the disclosure.

### BRIEF DESCRIPTION OF THE DRAWINGS

The above and/or additional aspects and advantages of the disclosure will become apparent and easy to understand from the descriptions of the embodiments with reference to the following drawings, wherein:

FIG. 1 is a system architecture diagram of a welding quality detection system in an embodiment of the disclosure;

FIG. 2 is a schematic structural diagram of an ultrasonic welding device in an embodiment of the disclosure;

FIG. 3 is a flowchart of a welding quality detection method in a first embodiment of the disclosure;

FIG. 4 is a specific flowchart of step S100 in FIG. 3;

FIG. 5 is a specific flowchart of step S300 in FIG. 3;

FIG. 6 is a flowchart of a welding quality detection method in a second embodiment of the disclosure; and

FIG. 7 is a system architecture diagram of a control module in an embodiment of the disclosure.

### REFERENCE NUMERALS

100 refers to ultrasonic welding device;

110 refers to welding quality detection system, 111 refers to detection module, 112 refers to control module, 1121 refers to memory, 1122 refers to processor, and 113 refers to display module;

120 refers to holder, and 121 refers to welding base;

130 refers to welding member, 131 refers to transducer, 132 refers amplitude modulator, and 133 refers to horn; and

140 refers to driving member.

### DETAILED DESCRIPTION

This part will describe the specific embodiments of the disclosure in detail, and the preferred embodiments of the disclosure are shown in the drawings. The drawings are used to supplement the description of the text in the specification with the graphs, so that people can intuitively and vividly understand each technical feature and the overall technical solution of the disclosure, but the drawings cannot be understood as limiting the scope of protection of the disclosure.

In the description of the disclosure, it should be understood that the orientations or positional relationships indicated by the terms such as “upper”, “lower”, “front”, “rear”, “left”, “right” and the like, refer to the orientations or positional relationships shown in the drawings, which are only intended to facilitate describing the disclosure and simplifying the description, and do not indicate or imply that the indicated devices or elements must have a specific orientation, be constructed and operated in a specific orientation, and therefore cannot be understood as a limitation of the disclosure.

In the description of the disclosure, “several” means one or more, “a plurality of” means two or more, “greater than a number”, “less than a number”, “exceed a number” and the like indicate that the number is excluded, and “above a number”, “below a number”, “within a number”, and the like indicate that the number is included. “First” and “second” if described are only used to distinguish between technical features but cannot be used to indicate or imply relative importance or implicitly specify a quantity of indicated technical features or implicitly specify a sequential relationship of indicated technical features.

In the description of the disclosure, the terms “arrangement”, “installation”, “connection”, and the like should be understood in broad sense unless otherwise specified and defined. The specific meaning of the above terms in the disclosure may be reasonably determined according to specific contents of the technical solutions by those having ordinary skills in the art.

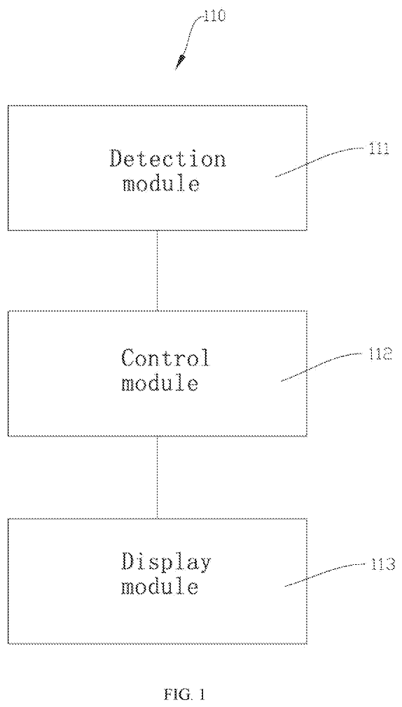

FIG. 1 shows a welding quality detection system 110 provided by some embodiments in a first aspect of the disclosure, which is mounted on an ultrasonic welding device 100. The welding quality detection system 110 includes a detection module 111, a control module 112 and a display module 113. The control module 112 is electrically connected with the detection module 111, and the display module 113 is electrically connected with the control module 112.

In some embodiments, the detection module 111 is set as a multi-dimensional force sensor, and the multi-dimensional force sensor is capable of detecting force values in multiple directions. In the embodiment, the multi-dimensional force sensor collects a transverse friction force and a longitudinal welding pressure of a welded workpiece, wherein during ultrasonic welding, ultrasonic vibration is transverse displacement, which generates an alternating shearing force in a horizontal direction, the shearing force is equal to a friction force between two welded workpieces, which is namely the transverse friction force. A downward pressure in a vertical direction of a welding member 130 on the welded workpiece is the longitudinal welding pressure. Generally, the multi-dimensional force sensor collects the transverse friction force and the longitudinal welding pressure, then converts the same into analog voltage signals, and amplifies the analog voltage signals, so as to transmit the analog voltage signals to the control module 112, thus accurately collecting the transverse friction force and the longitudinal welding pressure of the welded workpiece. The control module 112 receives the analog signals of the transverse friction force and the longitudinal welding pressure of the detection module 111, and then analyzes and processes the same. The control module 112 may be a programmable logic controller (PLC) or a single chip microcomputer, which obtains corresponding force values through conversion processing using a program, so as to compare the force values with reference value ranges and obtain analysis results, which are used to judge whether the welded workpiece is a qualified product, and transmits the analysis results to the display module 113. The display module 113 may be a terminal device such as a human machine interface (HMI) or a personal computer (PC), which is capable of visually displaying the analysis results in a form of words to intuitively feed back the analysis results to an operator. Certainly, it can be understood that the display module 113 may also display the value of the transverse friction force and the value of the longitudinal welding pressure of the welded workpiece, and the reference value ranges, thus further improving intuitiveness of the analysis results. The display module 113 may also be an indicator lamp, which displays the analysis results through light colors. For example, if the welded workpiece is a qualified product, green light is displayed, and if the welded workpiece is an unqualified product, red light is displayed. Implementation of the display module 113 is not specifically limited herein.

In the technical solution provided by the embodiment, the detection module 111 collects the transverse friction force and the longitudinal welding pressure of the welded workpiece in real time, and the control module 112 receives the signals of the detection module 111, and analyzes and processes the transverse friction force and the longitudinal welding pressure of the welded workpiece, so as to judge whether the welded workpiece is a qualified product, and display the analysis results to the display module 113 for feeding back to an operator in real time. Therefore, the operator can judge the welding quality of the welded workpiece in real time, and find a workpiece with a welding defect in advance, thus avoiding a potential safety hazard or a cost waste caused by the defect in a later stage.

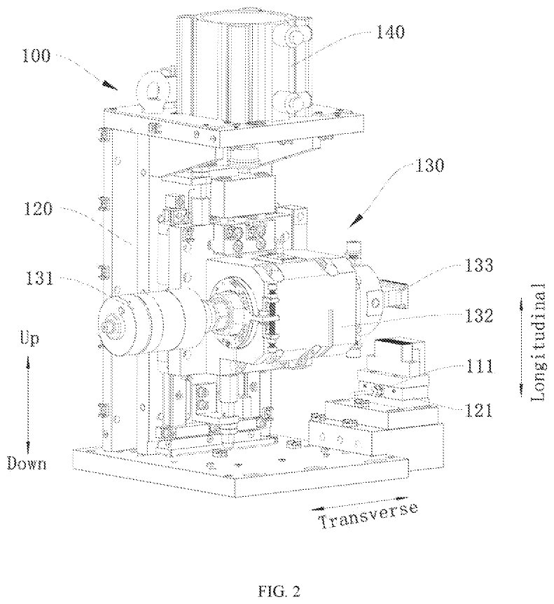

FIG. 2 shows an ultrasonic welding device 100 in a second aspect of the disclosure, which includes a holder 120, a welding member 130, a driving member 140 and the welding quality detection system 110 above. The holder 120 is provided with a welding base 121, and the welding base 121 is configured for positioning two welded workpieces. The welding member 130 is slidably connected to the holder 120 in an up-down direction, and the welding member 130 is set as a triplet, which includes a transducer 131, an amplitude modulator 132 and a horn 133 which are sequentially connected in a horizontal direction, wherein the horn 133 is located right above the welding base 121. The driving member 140 is fixedly mounted on the holder 120, the driving member 140 may be an air cylinder or other driving cylinders, and a driving shaft of the driving member 140 is connected with the welding member 130 and drives the welding member 130 to move up and down, so as to weld the workpiece. The detection module 111 (which is namely the multi-dimensional force sensor) in the welding quality detection system 110 is mounted on the welding base 121. During welding, end portions of two workpieces are placed on the welding base 121 in an abutted manner, and the driving member 140 drives the welding member 130 to move down, so that the horn 133 abuts against a joint between the two workpieces to realize welding by ultrasonic vibration. On one hand, a downward pressure in a vertical direction is applied to the workpiece when the horn 133 is pressed down, which is namely the longitudinal welding pressure, and on the other hand, an alternating shearing force is generated in a horizontal direction during ultrasonic vibration, and the shearing force is equal to a friction force between the two workpieces, which is namely the transverse friction force. The two forces above are affected by factors such as materials and coatings on surfaces of the workpieces, and welding stability and welding quality may be judged by the two forces above. During welding, the detection module 111 (the multi-dimensional force sensor) collects the transverse friction force and the longitudinal welding pressure of the welded workpiece in real time, and respectively converts the same into analog voltage signals to transmit to the control module 112. The control module 112 receives the analog voltage signals of the detection module 111, and then analyzes and processes the signals, so as to judge whether the welded workpiece is a qualified product in real time, and transmit analysis results to the display module 113 for intuitively feeding back the analysis results to an operator. Therefore, the operator can judge the welding quality of the welded workpiece in real time, and find a workpiece with a welding defect in advance, thus avoiding a potential safety hazard or a cost waste caused by the defect in a later stage.

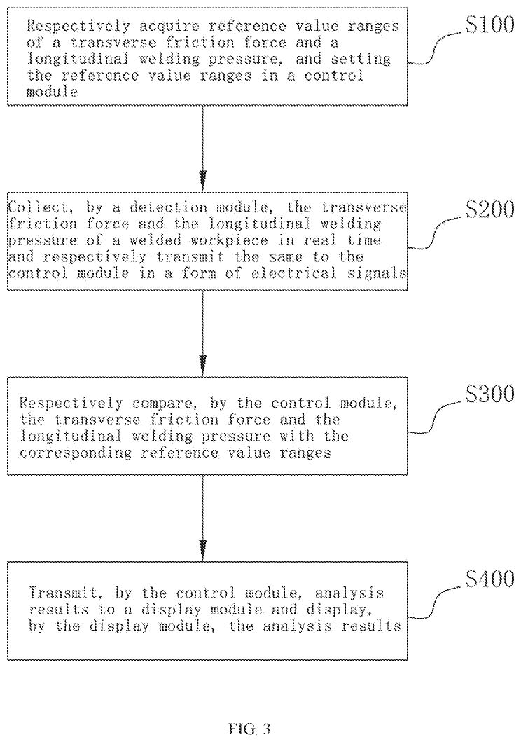

FIG. 3 to FIG. 5 show a welding quality detection method in a third aspect of the disclosure, which is applied to the ultrasonic welding device 100 in FIG. 2 and the welding quality detection system 110 in FIG. 1. The welding quality detection method in the embodiment may be realized by the detection module 111, the control module 112 and the display module 113 in the welding quality detection system 110 in some embodiments of the disclosure, so as to detect the welding quality of the welded workpiece in real time, judge whether the welded workpiece is a qualified product, and find a workpiece with a welding defect in advance. It should be noted that the following description is only illustrative, and is not a specific limitation of the disclosure.

FIG. 3 shows a welding quality detection method according to a first embodiment of the disclosure, which includes the following steps of:

step S100: respectively acquiring reference value ranges of the transverse friction force and the longitudinal welding pressure, and setting the reference value ranges in the control module 112;

step S200: collecting, by the detection module 111, the transverse friction force and the longitudinal welding pressure of the welded workpiece in real time and respectively transmitting the same to the control module 112 in a form of electrical signals;

step S300: respectively comparing, by the control module 112, the transverse friction force and the longitudinal welding pressure with the corresponding reference value ranges; and

step S400: transmitting, by the control module 112, the analysis results to the display module 113, and displaying, by the display module 113, the analysis results.

In the technical solution provided by the embodiment, the reference value range of the transverse friction force and the reference value range of the longitudinal welding pressure acquired in advance are set in the control module 112. The detection module 111 (which is namely the multi-dimensional force sensor) collects the transverse friction force and the longitudinal welding pressure of the welded workpiece in welding and converts the same into analog voltage signals. The control module 112 receives the analog voltage signals transmitted from the detection module 111, which are converted into corresponding force values by a program, so that the force values are capable of being compared with the preset reference value ranges, so as to judge whether the welded workpiece is a qualified product, and transmit the results to the display module 113 for intuitively feeding back the results to an operator. Therefore, the operator can judge the welding quality of the welded workpiece in real time, and find a workpiece with a welding defect in advance, thus avoiding a potential safety hazard or a cost waste caused by the defect in a later stage.

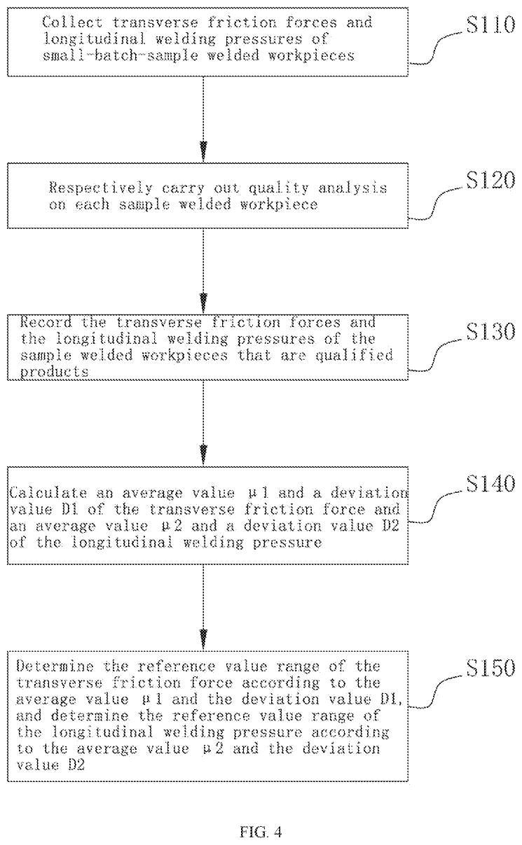

With reference to FIG. 4, based on the embodiment above, the step S100 of respectively acquiring the reference value ranges of the transverse friction force and the longitudinal welding pressure includes the following steps of:

step S110: collecting transverse friction forces and longitudinal welding pressures of small-batch-sample welded workpieces;

step S120: respectively carrying out quality analysis on each sample welded workpiece;

step S130: recording the transverse friction forces and the longitudinal welding pressures of the sample welded workpieces that are qualified products;

step S140: calculating an average value μ1 and a deviation value D1 of the transverse friction forces, and calculating an average value μ2 and a deviation value D2 of the longitudinal welding pressures; and

step S150: determining the reference value range of the transverse friction force according to the average value μ1 and the deviation value D1, and determining the reference value range of the longitudinal welding pressure according to the average value μ2 and the deviation value D2.

The reference value ranges are calculated according to data of the welded workpieces that are qualified products, and upper limiting values and lower limiting values of the reference value ranges are determined, so that the welding quality of the welded workpieces can be accurately judged, and whether welding parameters of the welded workpieces meet requirements can be quickly judged by upper and lower limiting comparison.

In some embodiments, the average value μ1 is taken by calculating a sum of the transverse friction forces of the sample welded workpieces that are qualified products, and a smaller one of a difference value between a maximum transverse friction force and the average value μ1 and a difference value between a minimum transverse friction force and the average value μ1 is taken as the deviation value D1, so that the reference value range of the transverse friction force is (μ1−D1) to (μ1+D1) (including endpoint values), which means that the reference value range of the transverse friction force has the upper limiting value of (μ1+D1) and the lower limiting value of (μ1−D1), wherein the upper limiting value and the lower limiting value are set in the control module 112. Certainly, it can be understood that, according to customer requirements or on-site process requirements, a range using double deviation 2D1, triple deviation 3D1 or other multiple deviation may be selected as the reference value range of the transverse friction force, so that the reference value range of the transverse friction force is (μ1−2D1) to (μ1+2D1) (including endpoint values), which means that the reference value range of the corresponding transverse friction force has the upper limiting value of (μ1+2D1) and the lower limiting value of (μ1−2D1), or the reference value range of the transverse friction force is (μ1−3D1) to (μ1+3D1) (including endpoint values), which means that the reference value range of the corresponding transverse friction force has the upper limiting value of (μ1+3D1) and the lower limiting value of (μ1−3D1), or others. Similarly, it may be obtained that the reference value range of the longitudinal welding pressure is (μ2−D2) to (μ2+D2) (including endpoint values), which means that the reference value range of the longitudinal welding pressure has the upper limiting value of (μ2+D2) and the lower limiting value of (μ2−D2), wherein the upper limiting value and the lower limiting value are set in the control module 112, which will not be repeated herein. Similarly, a range using double deviation 2D2, triple deviation 3D2 or other multiple deviation may be selected as the reference value range of the longitudinal welding pressure, which will not be repeated herein.

Based on the embodiment above, the step S120 of respectively carrying out the quality analysis on each sample welded workpiece includes tensile test and micro-structure analysis. The tensile test includes using a welding tensile tester to pull two welded workpieces to test fracture toughness of the welded workpieces, which means that whether a value of a tensile force that the two welded workpieces can bear meets limiting value requirements specified by industry standards or customers is judged. The micro-structure analysis includes observing a structure of a welding line or a welding spot by a professional precision instrument and measuring a parameter such as a residual area of the welding line or the welding spot, so as to judge whether the parameter of the welding line or the welding spot meets requirements of industry standards or customers. If the value of the tensile force and the parameter of the welding line or the welding spot both meet the requirements, the sample welded workpiece is judged as a qualified product, and the transverse friction force and the longitudinal welding pressure of the qualified product are recorded, otherwise the sample is judged as an unqualified product.

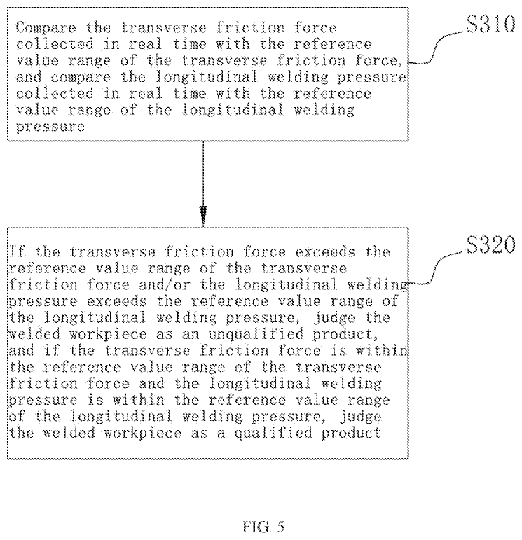

With reference to FIG. 5, based on the embodiment above, the step S300 of respectively comparing, by the control module 112, the transverse friction force and the longitudinal welding pressure with the corresponding reference value ranges includes the following steps of:

step S310: comparing the transverse friction force collected in real time with the reference value range of the transverse friction force, and comparing the longitudinal welding pressure collected in real time with the reference value range of the longitudinal welding pressure; and

step S320: if the transverse friction force exceeds the reference value range of the transverse friction force and/or the longitudinal welding pressure exceeds the reference value range of the longitudinal welding pressure, judging the welded workpiece as an unqualified product, and if the transverse friction force is within the reference value range of the transverse friction force and the longitudinal welding pressure is within the reference value range of the longitudinal welding pressure, judging the welded workpiece as a qualified product.

Whether the welded workpiece is a qualified product is quickly judged by comparing the force values in welding with the reference value ranges, thus having a high efficiency.

In some embodiments, the detection module 111 collects the transverse friction force and the longitudinal welding pressure of the welded workpiece in real time and converts the same into analog voltage signals. The control module 112 receives the analog voltage signals of the transverse friction force and the longitudinal welding pressure, then converts the same into identifiable values of the transverse friction force and the longitudinal welding pressure by a program, compares the value of the transverse friction force with the reference value range of the transverse friction force, which is to compare the value of the transverse friction force with the upper limiting value and the lower limiting value of the reference value range of the transverse friction force, and compares the value of the longitudinal welding pressure with the reference value range of the longitudinal welding pressure, which is to compare the value of the longitudinal welding pressure with the upper limiting value and the lower limiting value of the reference value range of the longitudinal welding pressure. In the following two conditions: 1) the value of the transverse friction force is within the reference value range of the transverse friction force, including the endpoint values of the reference value range of the transverse friction force; and 2) the value of the longitudinal welding pressure is within the reference value range of the longitudinal welding pressure, including the endpoint values of the reference value range of the longitudinal welding pressure, if the two conditions are met at the same time, the welded workpiece is judged as a qualified product, and the analysis result is transmitted to the display module 113, and displayed as “qualified” in the display module 113; and if only one of the conditions is met or neither of the conditions are met, the welded workpiece is judged as an unqualified product, and the analysis result is transmitted to the display module 113, and displayed as “unqualified” in the display module 113.

The welding quality of the welded workpiece can be quickly judged by upper and lower limiting value comparison, and the analysis results are intuitively displayed on the display module 113 for feeding back to an operator in real time. Therefore, the operator can judge the welding quality of the welded workpiece in real time and find a workpiece with a welding defect in advance, thus avoiding a potential safety hazard or a cost waste caused by the defect in a later stage.

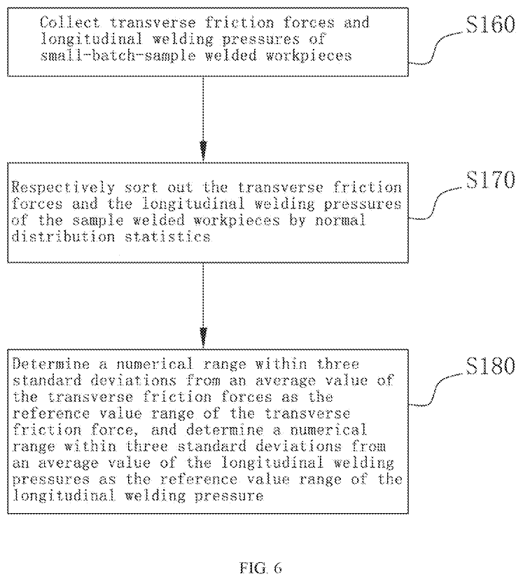

FIG. 6 shows a welding quality detection method according to a second embodiment of the disclosure, except the step S100 of respectively acquiring the reference value ranges of the transverse friction force and the longitudinal welding pressure, which is different from that of the first embodiment, the rest is the same as that of the first embodiment, which will not be repeated herein.

In the second embodiment, the step S100 of respectively acquiring the reference value ranges of the transverse friction force and the longitudinal welding pressure includes the following steps of:

S160: collecting transverse friction forces and longitudinal welding pressures of small-batch-sample welded workpieces;

S170: respectively sorting out the transverse friction forces and the longitudinal welding pressures of the sample welded workpieces by normal distribution statistics; and

S180: determining a numerical range within three standard deviations from an average value of the transverse friction forces as the reference value range of the transverse friction force, and determining a numerical range within three standard deviations from an average value of the longitudinal welding pressures as the reference value range of the longitudinal welding pressure.

Another type of reference value range can be acquired through acquiring the reference value range by the normal distribution statistics, thus further improving accuracy of welding quality detection.

In some embodiments, the values of the transverse friction forces of all samples are classified and counted. Taking the values of the transverse friction forces as an abscissa and a number of the samples corresponding to the values as an ordinate, data points of all samples are marked in the coordinate system. When a data volume of the samples is large enough, the values of the transverse friction forces conform to normal distribution, thus obtaining a normal distribution diagram of the transverse friction forces, and calculating an average value μ3 of the values of the transverse friction forces and a standard deviation σ3 of the values of the transverse friction forces. It can be understood that, in the normal distribution, a proportion within a range of μ3±3σ3 accounts for 99.73% of the total. Statistically, it is considered that <5% is a small probability event, while a probability of falling outside the range of μ3±3σ3 is 0.27%, which belongs to the small probability event, so that it is considered that if a data point falls outside the range of μ3±3σ3, it indicates that a welding process is abnormal, and the welded workpiece is judged as an unqualified product. Therefore, the reference value range of the transverse friction force may be determined as (μ3−3σ3) to (μ3+3σ3) (including endpoint values), which means that the upper limiting value of the reference value range of the transverse friction force is (μ3+3σ3) and the lower limiting value of the reference value range of the transverse friction force is (μ3−3σ3), wherein the upper limiting value and the lower limiting value are set in the control module 112. Similarly, the reference value range of the longitudinal welding pressure is determined as (μ4−3σ4) to (μ4+3σ4) (including endpoint values), which means that the upper limiting value of the reference value range of the longitudinal welding pressure is (μ4+3σ4) and the lower limiting value of the reference value range of the longitudinal welding pressure is (μ4−3σ4), wherein the upper limiting value and the lower limiting value are set in the control module 112, which will not be repeated herein. Therefore, another type of reference value range may be obtained. It can be understood that, when the control module 112 determines whether the transverse friction force and the longitudinal welding pressure of the welded workpiece meet requirements, the transverse friction force may be compared with the two types of reference value ranges of the transverse friction force, and similarly, the longitudinal welding pressure may be compared with the two types of reference value ranges of the longitudinal welding pressure, thus further improving accuracy of welding quality detection. Certainly, one type of reference value range may also be selected and set in the control module 112.

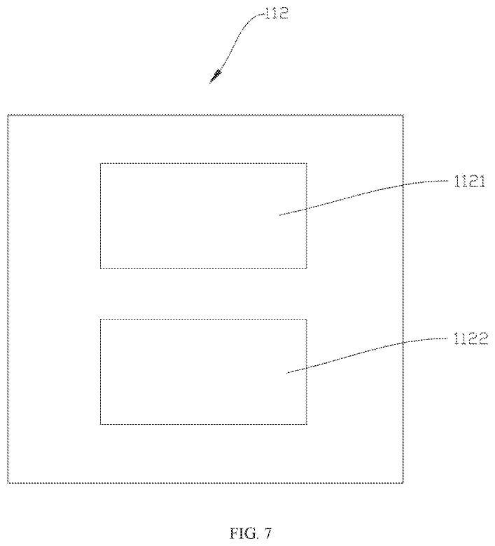

FIG. 7 shows a control module 112 in a fourth aspect of the disclosure, and the control module 112 may be any one of a control board, a control box or a control chip.

Specifically, the control module 112 includes one or more processors 1122 and one or more memories 1121, and one processor 1122 and one memory 1121 are taken as an example in the embodiment. The memory 1121 may be configured for storing a non-transient software program and a non-transient computer executable program, such as the welding quality detection method according to the embodiment in the third aspect of the disclosure. The processor 1122 implements the welding quality detection method according to the embodiment in the third aspect of the disclosure by running the non-transient software program and an instruction stored in the memory 1121, such as executing the step S100 to the step S400 and the step S310 to the step S320 in the description above.

A computer-readable storage medium in a fifth aspect of the disclosure is provided. The computer-readable storage medium stores a computer-executable instruction, and the computer-executable instruction is executed by one or more processors 1122, so that the processor 1122 executes the welding quality detection method according to the embodiment in the third aspect of the disclosure, such as executing the step S100 to the step S400 and the step S310 to the step S320 in the description above.

Those of ordinary skills in the art may understand that all or some of steps and systems in the method disclosed above may be implemented as software, firmware, hardware and appropriate combinations thereof. Some or all of the physical components may be implemented as software executed by a processor, such as a central processing unit, a digital signal processor or a microprocessor, or implemented as hardware, or implemented as an integrated circuit, such as an application-specific integrated circuit. Such software may be distributed on a computer-readable medium, and the computer-readable medium may include a computer storage medium (or a non-transitory medium) and a communication medium (or a transitory medium). As well known to those of ordinary skills in the art, the term ‘computer storage medium’ includes a volatile or nonvolatile, removable or non-removable medium implemented in any method or technology for storing information (such as a computer readable instruction, a data structure, a program module, or other data). The computer storage medium include but is not limited to RAM, ROM, EEPROM, flash memory or other memory technologies, CD-ROM, digital versatile disk (DVD) or other optical disk storage, magnetic box, magnetic tape, magnetic disk storage or other magnetic storage devices, or any other medium capable of being used to store desired information and accessed by a computer. Furthermore, it is well known to those of ordinary skills in the art that the communication medium typically includes a computer readable instruction, a data structure, a program module or other data in a modulated data signal such as a carrier wave or other transmission mechanism and may include any information delivery medium.

The embodiments of the disclosure are described in detail with reference to the drawings above, but the disclosure is not limited to the above embodiments, and various changes may also be made within the knowledge scope of those of ordinary skills in the art without departing from the purpose of the disclosure.

1. A welding quality detection system, comprising:
a detection module configured for collecting a transverse friction force and a longitudinal welding pressure of a welded workpiece;
a control module, wherein the control module is electrically connected with the detection module, and the control module is configured for receiving, analyzing and processing a transverse friction force signal and a longitudinal welding pressure signal of the detection module; and
a display module electrically connected with the control module, wherein the display module is configured for displaying analysis results of the control module.

2. The welding quality detection system according to claim 1, wherein the detection module comprises a multi-dimensional force sensor configured for collecting the transverse friction force and the longitudinal welding pressure of the welded workpiece and respectively converting the transverse friction force and the longitudinal welding pressure into analog voltage signals.

3. The welding quality detection system according to claim 1, wherein the display module comprises a human-machine interface (HMI), a personal computer (PC) or an indicator lamp.

4. An ultrasonic welding device, comprising:
a holder provided with a welding base;
a welding member slidably connected to the holder in an up-down direction, wherein the welding member is located above the welding base;
a driving member connected with the welding member and driving the welding member to move up and down; and
a welding quality detection system comprising:
a detection module configured for collecting a transverse friction force and a longitudinal welding pressure of a welded workpiece;
a control module, wherein the control module is electrically connected with the detection module, and the control module is configured for receiving, analyzing and processing a transverse friction force signal and a longitudinal welding pressure signal of the detection module; and
a display module electrically connected with the control module, wherein the display module is configured for displaying analysis results of the control module, wherein the detection module is mounted on the welding base.

5. A welding quality detection method applied in a welding quality detection system of an ultrasonic welding device, wherein the welding quality detection system comprises a detection module, a control module and a display module, the detection module is configured for collecting a transverse friction force and a longitudinal welding pressure of a welded workpiece, the control module is electrically connected with the detection module, the control module is configured for receiving, analyzing and processing a transverse friction force signal and a longitudinal welding pressure signal of the detection module, the display module is electrically connected with the control module, and the display module is configured for displaying analysis results of the control module, and the welding quality detection method comprises:
respectively acquiring reference value ranges of the transverse friction force and the longitudinal welding pressure, and setting the reference value ranges in the control module;
collecting, by the detection module, the transverse friction force and the longitudinal welding pressure of the welded workpiece in real time and respectively transmitting the transverse friction force and the longitudinal welding pressure to the control module in a form of electrical signals;
respectively comparing, by the control module, the transverse friction force and the longitudinal welding pressure with corresponding reference value ranges; and
transmitting, by the control module, the analysis results to the display module, and displaying, by the display module, the analysis results.

6. The welding quality detection method according to claim 5, wherein respectively acquiring reference value ranges of the transverse friction force and the longitudinal welding pressure comprises:
collecting transverse friction forces and longitudinal welding pressures of small-batch-sample welded workpieces;
respectively carrying out quality analysis on each sample welded workpiece;
recording the transverse friction forces and the longitudinal welding pressures of the sample welded workpieces that are qualified products;
calculating an average value μ1 and a deviation value D1 of the transverse friction forces, and calculating an average value μ2 and a deviation value D2 of the longitudinal welding pressures; and
determining the reference value range of the transverse friction force according to the average value μ1 and the deviation value D1, and determining the reference value range of the longitudinal welding pressure according to the average value μ2 and the deviation value D2.

7. The welding quality detection method according to claim 6, wherein the quality analysis comprises a tensile test and a micro-structure analysis.

8. The welding quality detection method according to claim 5, wherein respectively acquiring reference value ranges of the transverse friction force and the longitudinal welding pressure comprises:
collecting transverse friction forces and longitudinal welding pressures of small-batch-sample welded workpieces;
respectively sorting out the transverse friction forces and the longitudinal welding pressures of the sample welded workpieces by normal distribution statistics; and
determining a numerical range within three standard deviations from an average value of the transverse friction forces as the reference value range of the transverse friction force, and determining a numerical range within three standard deviations from an average value of the longitudinal welding pressures as the reference value range of the longitudinal welding pressure.

9. The welding quality detection method according to claim 8, wherein respectively sorting out the transverse friction forces and the longitudinal welding pressures of the sample welded workpieces by normal distribution statistics comprises: counting a number of values of the transverse friction forces and a number of values of the longitudinal welding pressures and respectively drawing normal distribution diagrams, and calculating the average value and the standard deviation of the transverse friction forces and calculating the average value and the standard deviation of the longitudinal welding pressures.

10. The welding quality detection method according to claim 5, wherein respectively comparing, by the control module, the transverse friction force and the longitudinal welding pressure with corresponding reference value ranges comprises:
comparing the transverse friction force collected in real time with the reference value range of the transverse friction force, and comparing the longitudinal welding pressure collected in real time with the reference value range of the longitudinal welding pressure; and
if the transverse friction force exceeds the reference value range of the transverse friction force and/or the longitudinal welding pressure exceeds the reference value range of the longitudinal welding pressure, judging the welded workpiece as an unqualified product, and if the transverse friction force is within the reference value range of the transverse friction force and the longitudinal welding pressure is within the reference value range of the longitudinal welding pressure, judging the welded workpiece as a qualified product.

11. The ultrasonic welding device according to claim 4, wherein the detection module comprises a multi-dimensional force sensor configured for collecting the transverse friction force and the longitudinal welding pressure of the welded workpiece and respectively converting the transverse friction force and the longitudinal welding pressure into analog voltage signals.

12. The ultrasonic welding device according to claim 4, wherein the display module comprises a human-machine interface (HMI), a personal computer (PC) or an indicator lamp.
